(19) United States
(12) Patent Application Publication
(10) Pub. No.: US 2018/0015598 A1
(43) Pub. Date: Jan. 18, 2018

(54) Plumbing Tool Apparatus

(71) Applicant: Paul R. Siddall, JR., Plymouth, IN (US)

(72) Inventor: Paul R. Siddall, JR., Plymouth, IN (US)

(21) Appl. No.: 15/212,851

(22) Filed: Jul. 18, 2016

(51) Int. Cl. B25B 27/00; B25B 27/30

(52) U.S. Cl. CPC B25B 27/0028; B25B 27/304

(57) ABSTRACT

A plumbing tool designed to easily remove and replace seats and springs in stem assembly, ball valve seat, or lever handle faucets.

### BACKGROUND

### 1. Field of the Invention

The present invention relates to plumbing tools and, more particularly, to a tool designed to easily remove and replace seats and springs in stem assembly, ball valve seat, or lever handle faucets.

### 2. Description of the Related Art

Professional plumbers are often frustrated with the tiny seats and springs found in many faucets. In both single and double-handle model faucets, the seats and springs add unneeded stress and time to plumbing repairs. Currently, screwdrivers are most often used for installing seats and springs, and it is necessary for any water flowing to the faucet to be completely stopped.

Unfortunately, known specialty tools for replacing springs and seats generally lack the durability and ease of use desired by plumbing professionals. For example, U.S. Pat. No. 6,904,653 (the “'653 patent”) and U.S. Pat. No. 7,062,827 (the “'827 patent”) disclose a tool for removing and inserting a plumbing fixture seal, particularly for use with ball type faucets using a rubber seal engaged by a cylindrical compression spring. However, the tool described in the '653 and '827 patents lacks the resiliency necessary for long term function and, as further described herein, its design cannot easily accommodate removal and replacement of seals and springs in many common plumbing situations.

Thus, what is needed in the art is a robust and easy to use tool for removing an placing seats and springs in any stem assembly, ball valve seat, or lever handle faucet in need of repair or replacement.

### SUMMARY

In an exemplary embodiment, the present invention comprises an apparatus for removing and inserting seals and springs in a faucet, said apparatus comprising: a handle, said handle comprising a cylindrical, longitudinal, inner bore, said bore having a longitudinal axis, said handle further comprising a threaded distal segment having a diameter and a proximal segment having a diameter, where said distal segment diameter is larger than said proximal segment diameter; a shaft, said shaft having a generally cylindrical shape and a cylindrical, longitudinal, inner bore, said bore having a longitudinal axis and a diameter, said shaft further comprising a distal end and a threaded proximal end, said shaft threadably connected to said handle such that said shaft bore and said handle bores are colinear; a rod, said rod having a generally cylindrical shape, said rod comprising a diameter, said rod diameter less than said diameter of said proximal segment of said bore, said rod diameter less than said diameter of said shaft bore, said rod slidably disposed through said shaft bore and said handle bores, said rod further comprising a distal tip, said tip comprising a proximal first outer diameter and a distal second outer diameter, said distal tip outer diameter less than said proximal tip outer diameter, said tip further comprising a taper disposed between said proximal outer diameter and said distal outer diameter; retaining means for preventing said rod from sliding completely through said proximal bore of said handle, said retention means disposed around said rod; a compression spring, said spring having an outer diameter and an inner diameter, said spring inner diameter disposed around said rod disposed around said rod distally relative to said retention means.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a side elevation view of an apparatus according to the present invention.

FIG. 2 shows an exploded view of the apparatus of FIG. 1.

FIG. 3 shows a side cross section view of the handle of the apparatus of FIG. 1.

FIG. 4 shows a side cross section view of the shaft of the apparatus of FIG. 1.

FIG. 5 shows a side elevation view of the rod of the apparatus of FIG. 1.

FIG. 6 shows a close up side elevation view of the tip of the rod in FIG. 5.

FIG. 7 shows a perspective view of the spring component of the apparatus of FIG. 1.

FIG. 8 shows a perspective view of the clip of the apparatus of FIG. 1.

FIG. 9 shows an exploded view of a prior art faucet on which the present invention may be used.

Corresponding reference characters indicate corresponding parts throughout the several views. The exemplary embodiments set forth herein are not to be construed as limiting the scope of the invention in any manner.

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

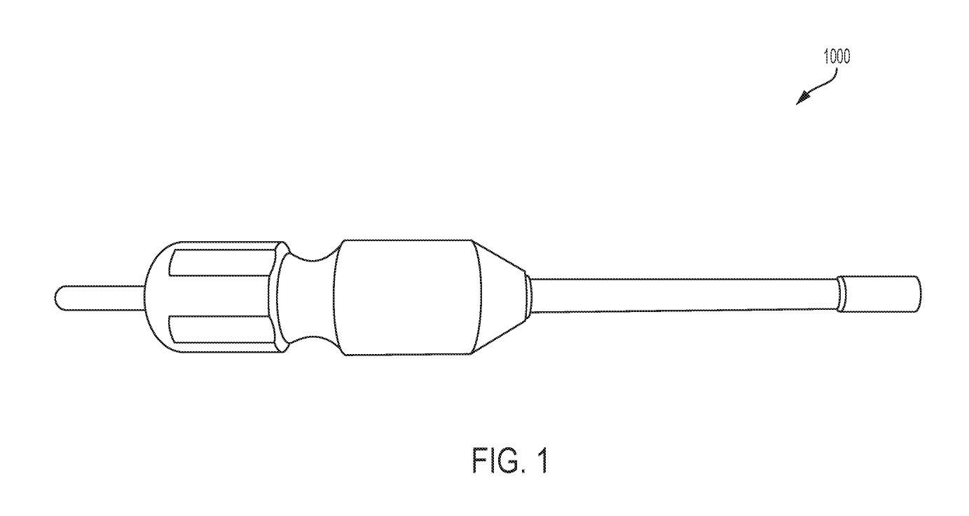

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Plumbing fixtures, specifically water faucets, often include a seal structure that controls the flow of water through the faucet. When the seal structure fails, the faucet leaks. Repairing the faucet requires replacing the seal.

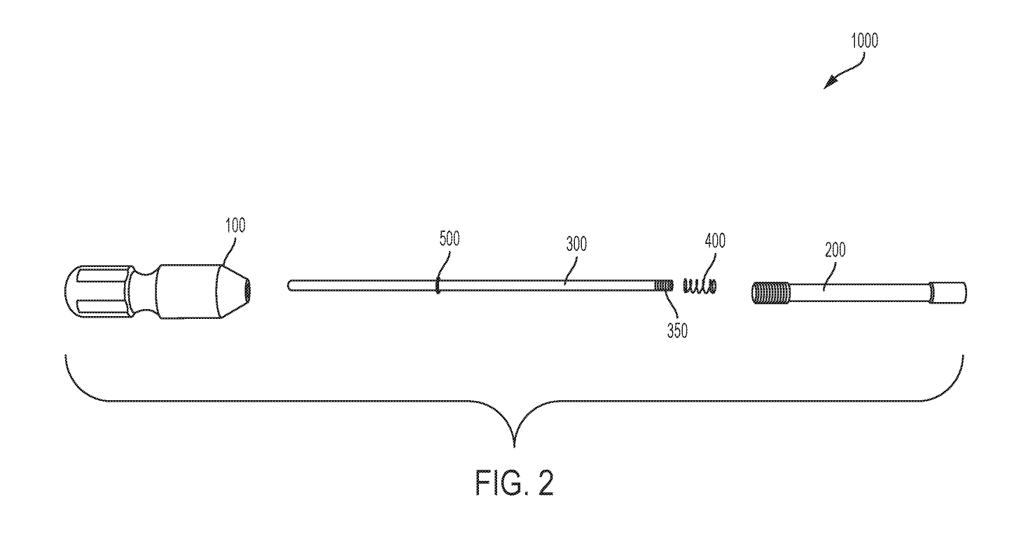

Referring first to FIG. 1, there is shown a side elevation view of plumbing tool apparatus 1000 according to the present invention for replacing a damaged faucet seal. As illustrated in FIG. 1 and FIG. 2, which shows an exploded view of the apparatus of FIG. 1, tool 1000 generally comprises a handle 100, shaft 200, rod 300, spring 400, and retention clip 500.

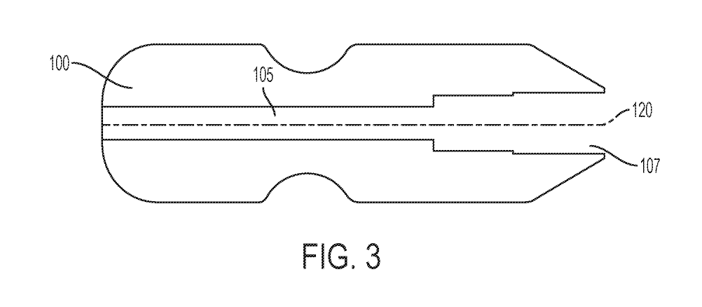

Referring next to FIG. 3, there is shown a side cross section view of handle 100 of apparatus 1000 shown in FIG. 1 and FIG. 2. As illustrated in FIG. 3, handle 100 comprises a generally cylindrical shape. In the exemplary embodiment of FIG. 3, handle 100 further comprises an ergonomically shaped exterior for easy manual use wherein the exterior comprises a relatively lower diameter. Handle 100 may comprise any material durable enough for multiple uses, corrosion resistant, and strong enough to withstand the forces acting on it during use of tool 1000. Exemplary embodiments of handle 100 may comprise aluminum, stainless steel, thermoplastic polymer, thermoset polymer, composite material, or carbon fiber material.

Referring still to FIG. 3, handle 100 further comprises a longitudinally disposed central bore 110 having a longitudinal axis 120. Bore 110 is formed from connected proximal bore 105 and larger diameter distal bore 107 disposed collinearly to one another such that both portions of bore 110 share a common longitudinal axis 120. As shown in FIG. 3, a “step” exists (as opposed to a taper) between the diameter of proximal bore 105 and distal bore 107.

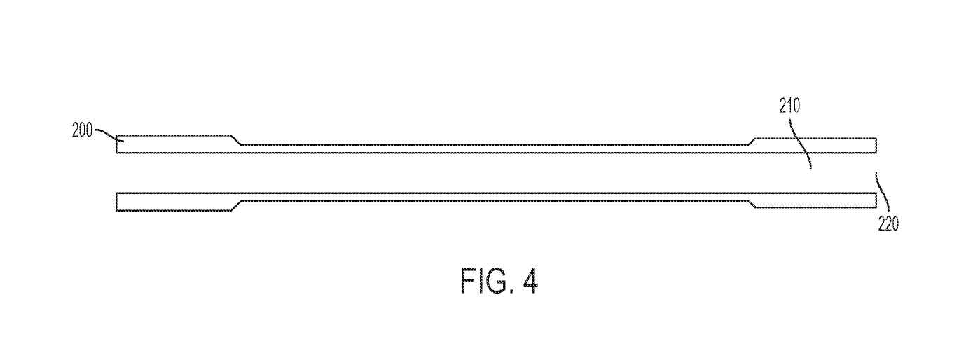

Referring next to FIG. 4, there is shown a side cross section view of shaft 200 of apparatus 1000 shown in FIG. 1 and FIG. 2. Shaft 200, in one exemplary embodiment, is comprised of aluminum. However, shaft 200 can also be comprised of stainless steel, thermoplastic polymer, thermoset polymer, composite material, or carbon fiber material, like handle 100. As illustrated in FIG. 4, shaft 200 includes a central, longitudinal bore 210 having a longitudinal axis 220. As shown in FIG. 1, shaft 200 is connected to handle 100. In one exemplary embodiment, shaft 200 is releasably connected to handle 100 by a threaded connection, a Morse taper connection, a snap-fit connection, or a twist-fit connection. Alternatively, shaft 200 and handle 100 may comprise a single molded or machined piece. In still another alternative embodiment of tool 1000, shaft 200 is fixedly connected to handle 100 by a heat weld, a sonic weld, an arc weld, a press fit, or an adhesive connection.

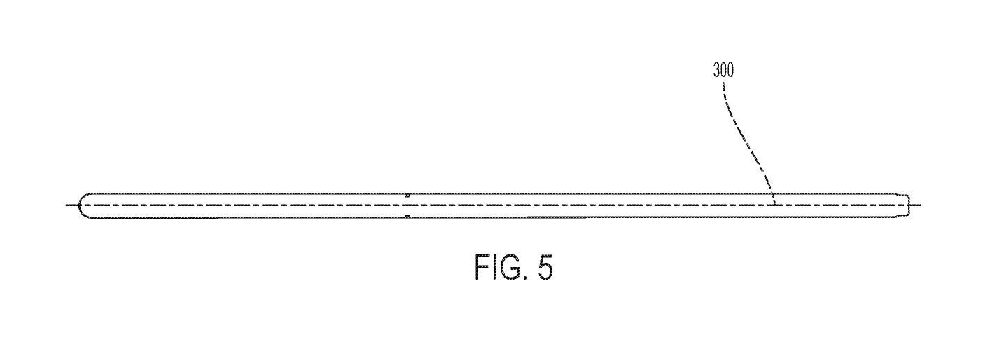

Referring next to FIG. 5, there is shown a side elevation view of rod 300 of apparatus 1000 shown in FIG. 1 and FIG. 2. In an exemplary embodiment, rod 300 is comprised of stainless steel, thermoplastic polymer, thermoset polymer, composite material, or carbon fiber material. Rod 200 comprises a generally cylindrical shape with an outer diameter smaller than the inner diameter of bore 105, bore 107, and bore 210 such that rod 300 is slidably disposed through handle 100 and shaft 200 as illustrated in FIG. 1.

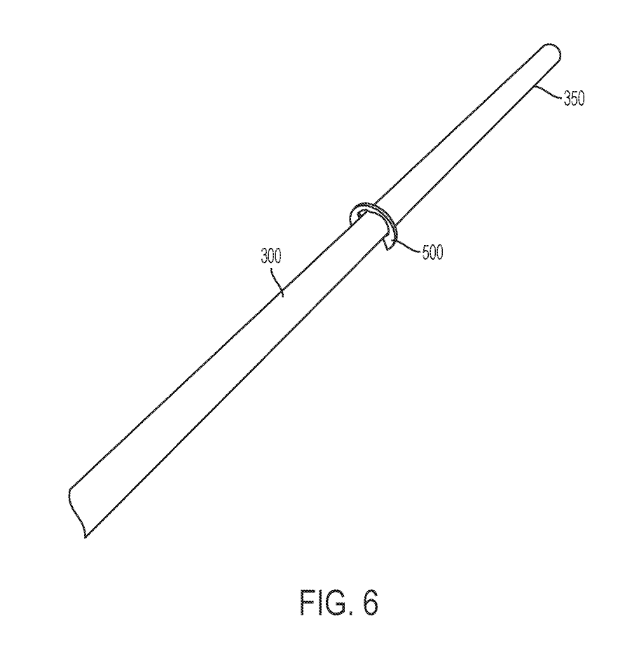

Referring next to FIG. 6, rod 300 further comprises tip 350. Tip 350 is disposed at the distal end of rod 300. Tip 350 comprises a distal outer diameter and a smaller proximal outer diameter. Preferably a taper exists between first and second outer diameters of tip 350. However, a taper is not required. Tip 350 further preferably included a roughened outer surface on at least the proximal outer diameter. The roughened surface preferably comprises a plurality of longitudinally disposed ridges. The diameter of tip 350 is sized to releasably fit into the inner diameter of a standard faucet seal and spring as described in more detail below.

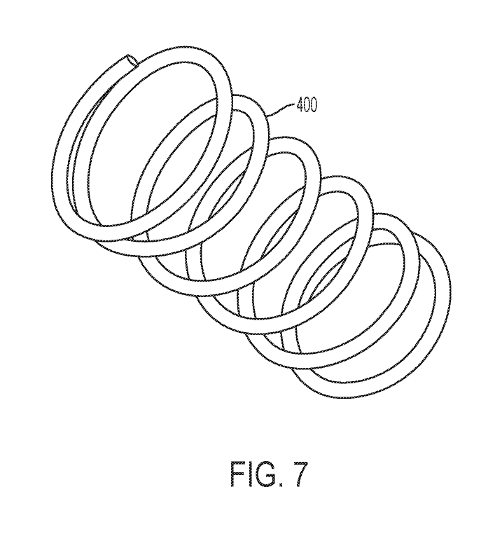

Referring next to FIG. 7, there is shown a perspective view of the spring component of the apparatus of FIG. 1. A resilient spring 400 is disposed around rod 300. Spring 400 acts to bias rod 300 back into shaft 200 when tool 1000 is not in use.

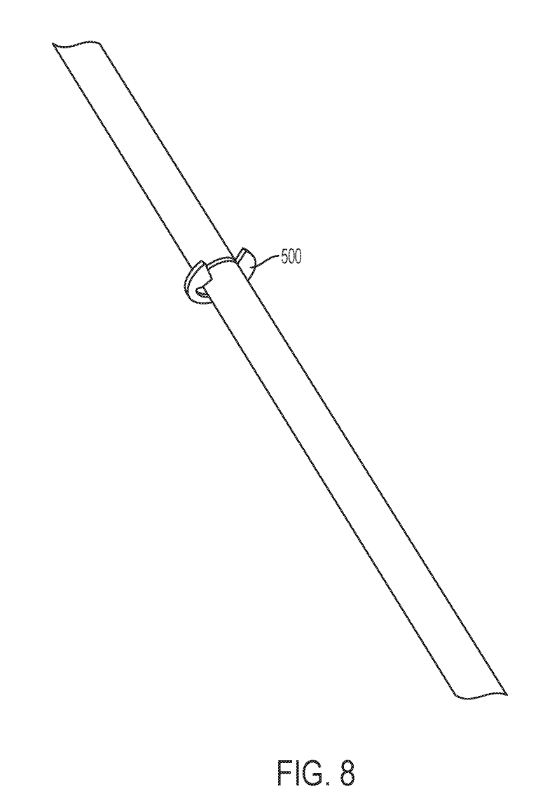

Referring next to FIG. 8, there is shown a perspective view of the clip of the apparatus of FIG. 1. Clip 500 comprises a flattened cylindrical shape and is fixedly attached around rod 300. Clip 500 is made of a stiff strong material such as stainless steel, thermoplastic polymer, thermoset polymer, composite material, or carbon fiber material.

When tool 1000 is fully assembled, as illustrated in FIGS. 1 and 2, rod 300 is forced through shaft 200. As this occurs, spring 400 is compressed against one end of shaft 200 and tip 350 of rod 300 extends from the opposite end of shaft 200. Once rod 300 is released, spring 400 pushes against clip 500 to return apparatus 1000 to an at rest position.

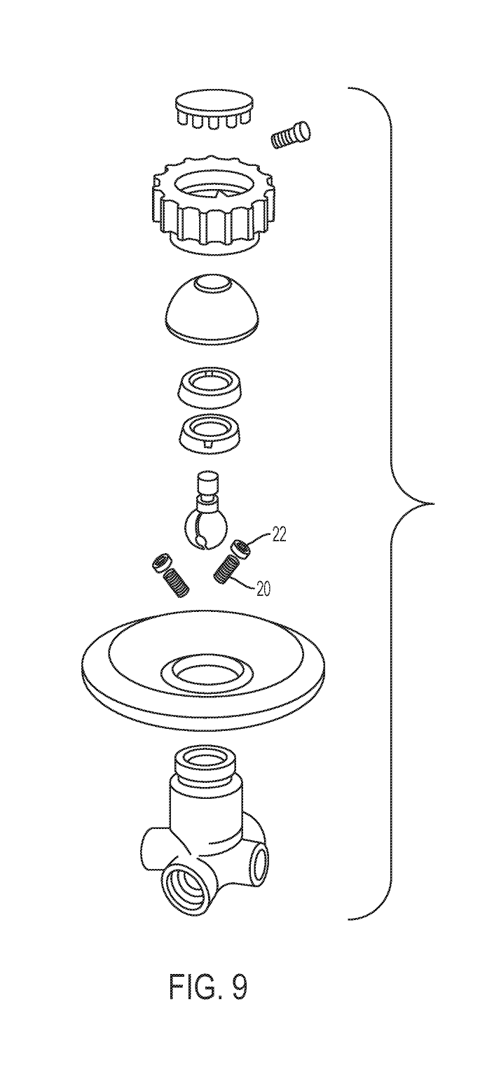

Referring next to FIG. 9, there is shown an exploded view of a prior art faucet on which the present invention may be used. The seal structure generally consists of a small, cylindrical, open-ended rubber seal and a small spring. The rubber seal may crack or break or the springs may lose their memory and fail to perform as intended, causing the faucet to leak. Replacement of this seal normally resolves the leak but is difficult because of the small size of the seal structure and the small area in which the structure is located. Normally, both the seal and the spring are replaced simultaneously.

The spring 20 and seal 22, shown in FIG. 9, are located in a predetermined location in the faucet that is difficult to remove and replace without great difficulty because of the small size of the spring 20 and seal 22 and the constrictions of the location. This is most notable in a bathtub faucet when the seal 20 and spring 22 require replacement. The faucet assembly is usually located in a vertical position and keeping the seal 22 and spring 20 in place while removing or inserting them is challenging. The present invention allows the old seal 22 and spring 20 to be removed together and replaced with a new seal 22 and spring 20 in unison while maintaining correct location placement.

A standard faucet valve assembly has a valve body with a main bore and a counterbore inlet passageway leading from a supply of water. The counterbore holds a tubular seal (seal 22 and spring 20) element in the inlet passageway of the valve body. The present invention enables the user to remove both the worn seal 22 and spring 20 together and replace a new seal 22 and spring 20 together. The spring 20 generally used in the industry is a frustoconical configuration with a smaller upper end, which engages the seal 22 and urges it against the valving member. The larger diameter of the conical spring 20 engages an annular shoulder of the counterbore. The seal 22 generally consists of a rubber or rubber-like composition with a through bore diameter that is comparable in size to the small end of the conical spring 20.

In use, apparatus 1000 is held in one hand during the removal or insertion of the spring 20 and seal 22. The rod 300 is pressed thereby causing tip 500 of rod 300 to be forced into the center of the worn spring 20 and seal 22. The worn spring 20 and seal 22 are held on the guide 30 by a friction fit. Once spring 20 and seal 22 are completely removed, rod 300 is released which causes tip 350 to retract and the spring 20 and seal 22 to fall off tip 350. The process is reversed place a new seal 22 and spring 20 into a faucet.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus for removing and inserting seals and springs in a faucet, said apparatus comprising:
a handle, said handle comprising a proximal, cylindrical, longitudinal, inner bore, said inner bore having a longitudinal axis and a diameter, said handle further comprising a distal, cylindrical, longitudinal, inner bore, said distal bore having a longitudinal axis and a diameter greater than the diameter of the proximal bore, said proximal bore and said distal bore disposed collinearly such that said proximal bore and said distal bore form a single bore having one longitudinal axis and two diameters;
a shaft, said shaft having a generally cylindrical shape and a cylindrical, longitudinal, inner bore, said bore having a longitudinal axis and a diameter, said shaft connected to said handle such that said shaft bore and said handle bores are colinear;
a rod, said rod having a generally cylindrical shape, said rod comprising a diameter, said rod diameter less than said diameter of said proximal segment of said bore, said rod diameter less than said diameter of said shaft bore, said rod slidably disposed through said shaft bore and said handle bores, said rod further comprising a distal tip, said tip comprising a proximal outer diameter and a distal outer diameter, said distal tip outer diameter less than said proximal tip outer diameter, said tip further comprising a taper disposed between said proximal outer diameter and said distal outer diameter;
retaining means for preventing said rod from sliding completely through said proximal bore of said handle, said retention means disposed around said rod;
a compression spring, said spring having an outer diameter and an inner diameter, said spring inner diameter disposed around said rod disposed around said rod distally relative to said retention means.

2. The apparatus of claim 1, wherein said shaft is releasably connected to said handle.

3. The apparatus of claim 2, wherein said shaft and said handle have a connection selected from the group consisting of a threaded connection, a Morse taper connection, a snap-fit connection, and a twist-fit connection.

4. The apparatus of claim 1, wherein said handle is made of a material selected from the group consisting of metal, thermoplastic polymer, thermoset polymer, composite material, and carbon fiber material.

5. The apparatus of claim 1, wherein said rod is made of a material selected from the group consisting of metal, thermoplastic polymer, thermoset polymer, composite material, and carbon fiber material.

6. The apparatus of claim 1, wherein said shaft is made of a material selected from the group consisting of metal, thermoplastic polymer, thermoset polymer, composite material, and carbon fiber material.

7. The apparatus of claim 1, wherein said tip further comprises a taper between said proximal tip diameter and said distal tip diameter.

8. The apparatus of claim 1, wherein said shaft is fixedly connected to said handle.

9. The apparatus of claim 8, wherein said shaft and said handle have a connection selected from the group consisting of a heat weld, a sonic weld, an arc weld, a press fit, and an adhesive connection.

10. The apparatus of claim 8, wherein said handle is made of a material selected from the group consisting of metal, thermoplastic polymer, thermoset polymer, composite material, and carbon fiber material.

11. The apparatus of claim 8, wherein said rod is made of a material selected from the group consisting of metal, thermoplastic polymer, thermoset polymer, composite material, and carbon fiber material.

12. The apparatus of claim 8, wherein said shaft is made of a material selected from the group consisting of metal, thermoplastic polymer, thermoset polymer, composite material, and carbon fiber material.

13. The apparatus of claim 8, wherein said tip further comprises a taper between said proximal tip diameter and said distal tip diameter.
